(19) United States
(12) Patent Application Publication
(10) Pub. No.: US 2026/0301482 A1
(43) Pub. Date: Oct. 1, 2026

(54) MONITORING A CONDITION OF A VEHICLE

(71) Applicant: INKALAB LTD, Wiltshire (GB)

(72) Inventor: Stephen Mark RETFORD, Wiltshire (GB)

(21) Appl. No.: 19/477,676

(22) PCT Filed: Apr. 24, 2024
(86) PCT No.: PCT/EP2024/061256

§ 371 Date: Oct. 22, 2025

(30) Foreign Application Priority Data
Apr. 24, 2023 (GB) 2305940.5

(51) Int. Cl. G07C 5/08; G07C 5/00

(52) U.S. Cl. CPC G07C 5/0808; G07C 5/008

(57) ABSTRACT

In some examples, a method for monitoring a condition of a vehicle comprising a sensor comprises measuring, by the sensor, at least one characteristic of the vehicle, transmitting the measurement to a remote processing module, analysing, by the remote processing module, the received measurement to determine a metric indicative of the condition of the vehicle, and transmitting the determined metric to the vehicle.

### TECHNICAL FIELD

The present disclosure relates to the technical field of vehicles, in particular to monitoring the noise and vibration condition of vehicles to predict the onset of faults.

### BACKGROUND

Maintenance and repair of a vehicle is a general concern to an owner or manufacturer of a vehicle. High costs are associated with loss of efficiency and performance, and downtime costs (in terms of components and labour required to repair/replace defective components) can be very high. Accordingly, maintenance systems have arisen to manage and control vehicle maintenance costs, reduce downtime, and increase reliability.

The existing automobile fault diagnosis and maintenance systems typically rely on on-board diagnostics, mainly used for monitoring the running condition of an engine and an exhaust. If a fault is detected, a warning can be displayed immediately to the operator of the vehicle, for example by switching on a fault indicator LED device. However, such indicators alerts the operator that a fault has occurred without providing accurate details of the fault. Furthermore, in some cases, if the fault is severe, the driver may be unable to take the vehicle to a vehicle maintenance point without employing external help. Maintenance has usually not been performed on a vehicle until the vehicle is broken down, resulting in excessive downtime of the vehicle and, potentially, additional costs and repairs that were caused because of the breakdown.

### SUMMARY

An objective of the present disclosure is to provide a system and method for monitoring a condition of a vehicle. The system is a low-cost, but high accuracy, real-time Noise, Vibration, Harshness (NVH) condition monitoring system. The system accurately monitors the degradation of rotating equipment over time, highlighting the likelihood of premature failure of components.

The foregoing and other objectives are achieved by the features of the independent claims.

Further implementation forms are apparent from the dependent claims, the description and the Figures.

A first aspect of the present disclosure provides a method for monitoring a condition of a vehicle comprising a sensor, the method comprising measuring, by the sensor, at least one characteristic of the vehicle, transmitting the measurement to a remote processing module, analysing, by the remote processing module, the received measurement to determine a metric indicative of the condition of the vehicle, and transmitting the determined metric to the vehicle.

Accordingly, by accurately monitoring the condition of the vehicle (for example, the degradation of rotating equipment over time), the likelihood of premature failure of components can be highlighted. This allows maintenance and/or repair activities to be scheduled at a lower cost before failure, ensuring that the vehicle continues to operate at optimum performance and efficiency.

In an implementation of the first aspect, the at least one characteristic of the vehicle comprises noise, vibration, and harshness. Thus, the condition of the vehicle can be determined based on the NVH characteristics.

The at least one characteristic of the vehicle may comprise at least one characteristic of a component of a vehicle.

Measuring, by the sensor, the at least one characteristic of the component of the vehicle may comprise performing the measurement in relation to the particular component of the vehicle, whereby to obtain metrics relating to that particular component only, wherein the remote processing module analy ses the received measurement to determine a metric indicative of the condition of the particular component.

The metric indicative of the condition of the vehicle may comprise a metric indicative of the condition of a component of a powertrain of the vehicle.

The measurements may be transmitted to the remote processing module in real time. Thus, the condition of the vehicle can be monitored in real time.

The method may further comprise the step of compressing the measurement before transmitting it to the cloud-based processing module. Thus, the data file(s) containing the measurement can be transmitted faster.

Determining the metric indicative of the condition of the vehicle may comprise comparing the received measurement to a threshold value. Thus, problems relating to the performance of the vehicle can be easily identified by comparing the received measurements to expected values.

The method may further comprise measuring vehicle speed, acceleration, mass, and road inclination, and estimating a torque load of a component of the vehicle based thereon.

The threshold value to which the measurement is compared to may be selected based on a current operational mode of the vehicle. Thus, issues relating to the performance of the vehicle can be accurately identified for each performance mode of the vehicle.

The threshold value to which the measurement is compared to may be selected based on a rotational speed of the component of the vehicle and the torque load of the component of the vehicle.

The method may further comprise the step of transmitting the determined metric to an external entity. Thus, data relating to the condition of the vehicle can be shared with, for example, a manufacturer of the vehicle, enabling them to take action if necessary and flagging potential issues with a batch of manufactured vehicles.

The method may further comprise the step of displaying a message in the vehicle in response to receiving the determined metric. Thus, a user of the vehicle can be alerted to issues with the condition/performance of the vehicle.

The method may further comprise measuring a vehicle suspension angle when the vehicle is stationary, and determining a laden vehicle mass based thereon.

A second aspect of the present disclosure provides an apparatus for monitoring a condition of a vehicle, the apparatus comprising a processor, a memory coupled to the processor, the memory configured to store program code executable by the processor, the program code comprising one or more instructions, whereby to cause the apparatus to receive, from the sensor, at least one characteristic of the vehicle measured by the sensor, analyse the received measurement to determine a metric indicative of the condition of the vehicle, and transmit the determined metric to the vehicle.

Accordingly, by accurately monitoring the condition of the vehicle (for example, the degradation of rotating equipment over time), the likelihood of premature failure of components can be highlighted. This allows maintenance and/or repair activities to be scheduled at a lower cost before failure, ensuring that the vehicle continues to operate at optimum performance and efficiency.

In an implementation of the second aspect, the program code may comprise one or more further instructions, whereby to cause the apparatus to compare the received measurement to a threshold value stored in the memory to thereby determine the metric indicative of the condition of the vehicle. Thus, problems relating to the performance of the vehicle can be easily identified by comparing the received measurements to expected values.

The program code may comprise one or more further instructions, whereby to cause the apparatus to determine a current operational mode of the vehicle, and select the threshold value amongst a plurality of threshold values stored in the memory based on the determined operational mode of the vehicle. Thus, the apparatus can accurately determine the condition of the vehicle by keeping in consideration the fact that the measured characteristics of the vehicle are dependent on the current operational mode of the vehicle.

The program code may comprise one or more further instructions, whereby to cause the apparatus to transmit the determined metric to an external entity. Thus, data relating to the condition of the vehicle can be shared with, for example, a manufacturer of the vehicle, enabling them to take action if necessary and flagging potential issues with a batch of manufactured vehicles.

A third aspect of the present disclosure provides a machine-readable storage medium encoded with instructions for monitoring condition of a vehicle, the instructions executable by a processor of an apparatus, whereby to cause the apparatus to receive, from the sensor, at least one characteristic of the vehicle measured by the sensor, analyse the received measurement to determine a metric indicative of the condition of the vehicle, and transmit the determined metric to the vehicle.

Accordingly, by accurately monitoring the condition of the vehicle (for example, the degradation of rotating equipment over time), the likelihood of premature failure of components can be highlighted. This allows maintenance and/or repair activities to be scheduled at a lower cost before failure, ensuring that the vehicle continues to operate at optimum performance and efficiency.

In an implementation of the third aspect, the machine-readable storage medium may be encoded with further instructions executable by the processor of the apparatus, whereby to cause the apparatus to compare the received measurement to a threshold value stored in the memory to thereby determine the metric indicative of the condition of the vehicle. Thus, problems relating to the performance of the vehicle can be easily identified by comparing the received measurements to expected values.

In an implementation of the third aspect, the machine-readable storage medium may be encoded with further instructions executable by the processor of the apparatus, whereby to cause the apparatus to determine a current operational mode of the vehicle, and select the threshold value amongst a plurality of threshold values stored in the memory based on the determined operational mode of the vehicle. Thus, the apparatus can accurately determine the condition of the vehicle by keeping in consideration the fact that the measured characteristics of the vehicle are dependent on the current operational mode of the vehicle.

### BRIEF DESCRIPTION OF THE DRAWINGS

In order that the present invention may be more readily understood, embodiments of the invention will now be described, by way of example, with reference to the accompanying drawings, in which:

FIG. 1 is a flowchart of a method according to an example;

FIG. 2 is a schematic representation of an apparatus for monitoring condition of a vehicle according to an example;

FIG. 3 is a schematic representation of a system for monitoring condition of a vehicle according to an example;

FIG. 4 is a schematic representation of a grid for analysing the condition of a vehicle according to an example; and

FIG. 5 is a schematic representation of stacked grids according to an example.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

As science and technology develop, people are becoming more accustomed to a higher standard of living. More importance is placed on quality of vehicles, as well as the comfort associated with using them. One metric through which the manufacturing quality of the vehicles can be measured is NVH (Noise, Vibration, Harshness).

Noise, which is measured in decibel (dB), is roughly classified as interior noise generated by vehicle parts and exterior noise generated from the outside of the vehicle from sources such as the tyres and wind. Vibration includes interior vibration due to an operation of an internal part such as an engine or a driveline, and exterior vibration transferred to the vehicle through the vehicle body, a tire, or a suspension from friction with the road surface, the wind, and the like. Harshness refers to the adverse subjective assessment of noise and/or vibration by an irregular impact; for example, when a vehicle drives over speed bumps installed on the road or drives across railroad tracks.

At present, measuring/monitoring the NVH requires professional test equipment to be used. Such approach is associated with high cost, is time consuming, and may not produce accurate results, as the readings are obtained under unrealistic conditions, and do not necessarily reflect the NVH conditions experienced by the vehicle operator.

According to an example, there is provided an apparatus and a method for monitoring the condition of a vehicle. The apparatus is able to monitor the transmissions, axles, engines, gear trains and bearings, to thereby determine the NVH condition. The apparatus monitors the condition of the vehicle in real-time and can be used to predict the likelihood of premature failure of the components, in turn increasing the performance and efficiency of the vehicle, and guiding future developments.

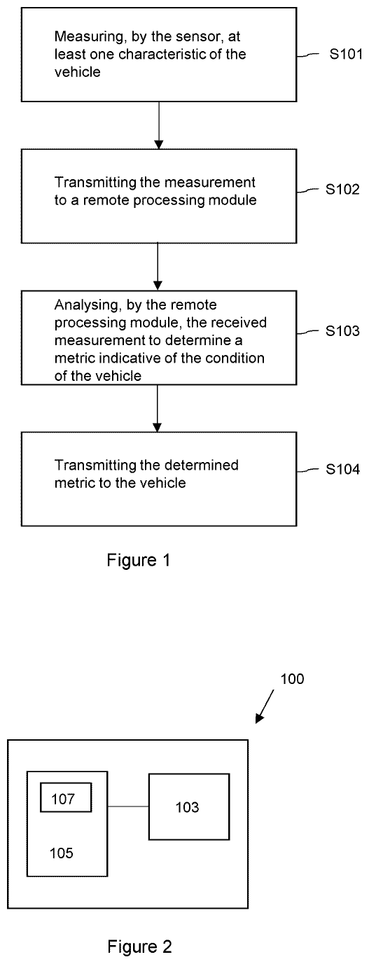

FIG. 1 is a flowchart of a method according to an example. In step S101, the method for monitoring a condition of a vehicle comprising a sensor comprises measuring, by the sensor, at least one characteristic of the vehicle. The condition of the vehicle may comprise the noise, vibration, harshness (NVH) condition.

The vehicle may comprise at least one sensor. The sensor may comprise a microphone, an accelerometer, a force gauge, or a load cell. The sensor may be directly or indirectly fitted to a bearing, a transmission, an axle/differential unit, an engine, and/or a gear train. In one example, the sensor may be fitted adjacent to a bearing. The sensor may be connected to a communications module of the vehicle to enable transmission of the measurements. The sensors may be hard wired to a part of the vehicle, but are not limited thereto. In an example, Bluetooth sensors may be employed to acquire the measurements.

The at least one characteristic of the vehicle may comprise noise, vibration, and/or harshness. In addition to being representative of an operator's comfort when operating the vehicle, these characteristics can be used to detect and predict mechanical faults in vehicle components. The at least one characteristic of the vehicle may relate to a specific component of the vehicle and/or a component of the powertrain of the vehicle. The at least one characteristic of the vehicle may be measured in relation to the specific component of the vehicle and/or the powertrain of the vehicle, whereby to obtain metrics (characteristics) relating to that particular component and its performance.

Here, the term “vehicle powertrain” may comprise the integrated system of components that work together to generate, transmit, and deliver power to move a vehicle. The vehicle powertrain may include a propulsion source, such as an internal combustion engine or electric motor, as well as various transmission elements like gearboxes, axles, and differentials that transfer power from the propulsion source to the wheels. Bearings may also be part of the powertrain, providing support and reducing friction in the movement of these components.

In step S102, the method comprises transmitting the measurement obtained from the sensor to a remote processing module. In general, the “remoteness” of the processing module here intends to refer to the fact that the processing module is not a pre-fitted part of the vehicle; for example, the remote processing module is not, or is not part of, the vehicle's on-board computer/processing system. The remote processing module may comprise a cloud-based module.

In an example, transmitting the measurement obtained from the sensor to the remote processing module may involve sending data packets comprising the obtained data wirelessly. For example, the data packets may be sent to the remote processing module by using the vehicle's existing communication capabilities, such as WLAN technology, or a cellular network. The data packets may be sent to the remote processing module by ‘piggybacking’ the existing vehicle GSM. Alternatively or additionally, vehicle-to-everything (V2X) communication may be employed.

The data packets may be sent to the remote processing module substantially in real-time, or periodically, in regular intervals, for example once every 10 minutes. The frequency at which measurements are obtained from the sensor and sent to the remote processing module may depend on the determined condition of the vehicle; for example, more frequent monitoring of the vehicle may be performed in response to the condition of the vehicle being determined as worsening.

The measurement (that is, the data packets comprising the measurement) may be compressed prior to being transmitted to the remote processing module.

In step S103, the method comprises analysing, by the remote processing module, the received measurement to determine a metric indicative of the condition of the vehicle. The remote processing module may analyse the received measurements to gauge performance/degradation of a part of the vehicle from which the sensor obtained the measurement. The metric indicative of the condition of the vehicle may be, for example, a prediction of when a certain part of the vehicle should be serviced/replaced (e.g. that a bearing is likely to wear out after 100 miles travelled), or an indication that the certain part appears to be malfunctioning, and that further diagnostics are required.

In other words, the remote processing module may analyse the received measurement to provide an indication of the vehicle's health, for example, in order to determine or predict a fault of the components of the powertrain.

If the received measurement relates to a specific component of the vehicle, the remote processing module may analyse the received measurement to determine the condition of that particular component of the vehicle. For example, the condition of the automotive powertrain can be assessed by measuring vibration responses at key locations within the vehicle. Normal (i.e., everyday) driving typically requires the vehicle to operate across a range of speeds and a range of torque loads. Vibration responses from the powertrain are specific to the instantaneous combination of speed and load. If the operational envelope of the vehicle is defined in terms of Speed (MPH) and Torque Load, and divided into cells, the vibration measured in a first cell will have different characteristics and levels to vibration measured in a second cell different from the first cell.

To analyse the condition of a vehicle in such a manner, real-time measurements of rotational speed and torque loading are required. However, sensors for direct measurement of powertrain torque are expensive and seldom standard fitment on vehicles. Some vehicle OBD (on-board diagnostic) systems can provide torque estimates but, for ICE-powered vehicles, those estimates are inlet vacuum based and hence positive load only. Typically, measurement of NVH characteristics and their analysis is performed, for example, during vehicle check-ups performed by the manufacturer, or after the vehicle has been assembled (i.e., prior to the vehicle being delivered to a seller). Advantageously, the method described herein comprises real-time measurement of NVH characteristics during regular use of a vehicle, and determining the condition of the vehicle's components based thereon.

The vehicle powertrain torque loading may comprise a function of four main variables:
a. vehicle speed (increased speed requires increased torque to overcome frictional and aerodynamic “drag” forces). Prime mover type and powertrain type may dictate the type of sensor(s) and signal conditioning required for rotational speed measurement;
b. vehicle acceleration (more, positive, torque is required to accelerate a vehicle, whereas a decelerating vehicle can impart opposite polarity, negative toque on the powertrain, so-called “overrun” or “coast” load. Acceleration can be computed from instantaneous powertrain speed (and any discrete gear ratio currently engaged);
c. vehicle mass, m;
d. road inclination.

The metric indicative of the condition of the vehicle may comprise a metric indicative of the condition of the powertrain of the vehicle. The method may comprise estimating the vehicle powertrain torque using measured/known characteristics such as vehicle speed, acceleration, mass, and road inclination.

When travelling at a constant speed on a flat surface, a vehicle's powertrain may be positively loaded (so-called “drive torque”), so as to overcome the frictional and aerodynamic (i.e., drag) forces. When travelling at a constant speed up an inclined road, the vehicle's powertrain may be more positively loaded in order to overcome the gravitational force (in additional to the frictional and drag forces). When travelling at a constant speed down an incline (with braking), the vehicle's powertrain may be negatively loaded (so-called coast, or overrun torque) as gravitational forces outweigh frictional and aerodynamic forces.

In order to determine the metric indicative of the condition of the vehicle, the remote processing module may compare the measurement received from the sensor to a threshold value. The threshold value to which the measurement is compared to may be selected based on current operational mode of the vehicle. For example, if the measurement relates to vibration, the vibration analysis may be specific to instantaneous speed and torque, such that the threshold value is selected depending on the speed and torque. FIG. 4 is a schematic representation of a grid for analy sing the condition of a vehicle according to an example. Measured speed 401 and torque 402 may be envisaged using a 2D grid, with vibration analysis specific to the current position (cell) 403 within the grid.

The remote processing module may have access to a plurality of pre-stored profiles for each operational mode of the vehicle, respectively. Each pre-stored profile may be associated with different threshold values. That is, depending on the operational mode of the vehicle, different values of NVH might be considered abnormal and thus indicative of a fault occurring. The pre-stored profiles may be generated by the remote processing module when the apparatus is first deployed. That is, the remote processing module may determine a noise/vibration signature (threshold value) to later be used for the determination of the metric indicative of the condition of the vehicle.

The remote processing module may automatically determine the operational mode of the vehicle based on the received measurement. The remote processing module may also receive information indicating the operational mode of the vehicle separately from the measurement received from the sensor, or together with the measurement received from the sensor. Information indicating the operational mode of the vehicle may comprise, for example, an indication of what gear the vehicle is in, what mode (for example, eco) the vehicle is operating in, or occupancy information of the vehicle. For example, for automotive powertrains and associated components, a vibration response may depend on speed (RPM) and torque loading. To ensure accurate determination of the metric indicative of the condition of the vehicle, the measured NVH may be compared on a like-for-like basis to a profile corresponding to the operational mode of the vehicle.

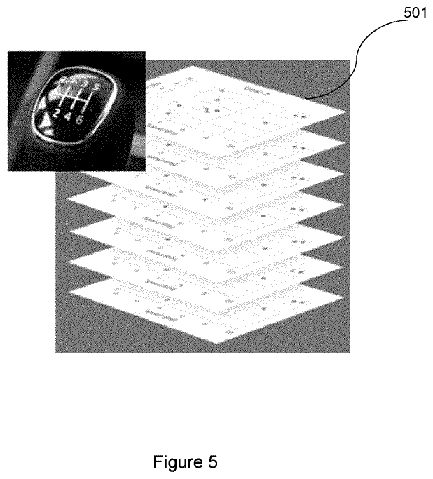

The operational mode of the vehicle may comprise the operational mode of the powertrain of the vehicle. The vehicle's powertrain may move through a series of discrete operational setups, the most common of which is various gear ratios between the prime mover (internal combustion engine or eMotor) and the road wheels. Each discrete operational mode may require a separate speed-load grid, which can be envisaged as a 3D stacked series of grids 501, as shown in FIG. 5, which is a schematic representation of stacked grids according to an example.

In a specific example, analysis of the vibration of a shaft speed may be performed in order to determine component specific powertrain health monitoring data. In particular, the invention may utilise the rotational speed of the vehicle's powertrain to perform order analysis and revolution event analysis. This allows condition data and trends to be assigned to specific parts of the powertrain.

The method may also comprise measuring a vehicle suspension angle when the vehicle is stationary, and determining a laden vehicle mass based thereon. The mass of any vehicle may vary with the load being carried, for example, depending on the number of passengers in the vehicle, payload, and similar. As the mass of the vehicle is increased, the static deflection of the suspension may also increase, which is accompanied by a change in suspension element angle. Measurement of a key suspension element angle (e.g., a wishbone or a trailing arm), can therefore be used to estimate laden vehicle mass. This indirect measurement of vehicle mass can only be made when the vehicle is stationary, as the suspension element will move through a range of angles when the vehicle is moving.

In step S104, the method comprises transmitting the determined metric to the vehicle. For example, the determined metric may be transmitted to the vehicle's on-board computer. In response to receiving the determined metric by the vehicle, a message may be displayed in the vehicle using a display module. The displayed message may be, for example, a prompt for the vehicle's operator to take the vehicle to a service centre, or a notification that a part of the vehicle will need to be replaced after a certain distance has been travelled.

In addition to transmitting the determined metric to the vehicle, the method may also comprise the step of transmitting the determined metric to a vehicle's manufacturer. This may enable the manufacturer to identify a fault within a certain batch of produced vehicles (for example, if multiple vehicles having the same manufacturing date and the manufacturing place are experiencing failures) and/or provide data to guide future developments.

FIG. 2 is a schematic representation of an apparatus for monitoring a condition of a vehicle. The apparatus 100 comprises a processor 103 and a memory 105, the memory 105 coupled to the processor 103, the memory configured to store program code 107 executable by the processor 103, the program code 107 comprising one or more instructions to cause the apparatus 100 to receive, from a sensor, at least one characteristic of the vehicle, measured by the sensor. The at least one characteristic may comprise noise, vibration, and harshness. The apparatus 100 then analyses the received measurement to determine a metric indicative of the condition of the vehicle, and transmits the determined metric to the vehicle.

The apparatus 100 may be arranged to compare the received measurement to a threshold value stored in the memory 105 to thereby determine the metric indicative of the performance of the vehicle. The apparatus 100 may be arranged to determine an operational mode of the vehicle and select the threshold value amongst a plurality of threshold values stored in the memory 105 based on the determined operational mode of the vehicle. The apparatus 100 may be arranged to determine the operational mode of the vehicle based on the received measurement, or receive information indicating the operational mode of the vehicle from the vehicle.

The apparatus 100 may be arranged to transmit the determined metric to an external entity, i.e. an entity other than the vehicle to which the received measurements relate to.

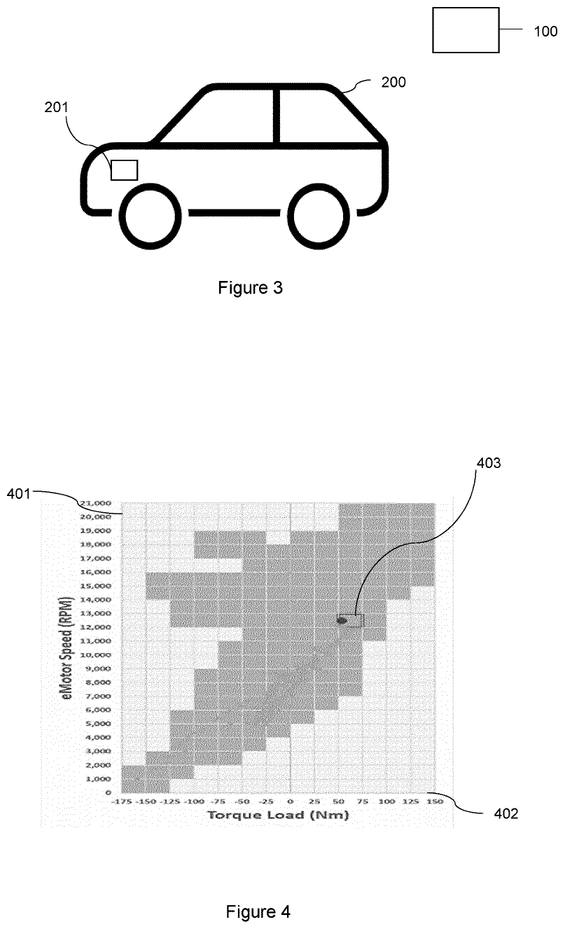

FIG. 3 is a schematic representation of a system for monitoring a condition of a vehicle. The system 300 may comprise the apparatus 100 (described above in relation to FIG. 2) and the vehicle 200. The apparatus 100 may be located inside the vehicle 200, or may be located externally to the vehicle 200, in which case the apparatus 100 may communicate with the vehicle 200 via wireless communication. The vehicle 200 comprises at least one sensor 201. The sensor 201 may comprise a microphone, an accelerometer, a force gauge, or a load cell. The sensor 201 may be fitted to any part of the vehicle 200, for example, a bearing, a transmission, an axle, an engine, and/or a great train. The sensor 201 may be connected to a communications module of the vehicle.

In an example, the vehicle 200 may comprise a plurality of sensors 201 attached to different parts of the vehicle 200. That is, the vehicle 200 may obtain measurements to monitor the condition of a part of the vehicle on a component level, rather than as a whole, enabling more precise identification of a source of any potential problem.

Examples in the present disclosure can be provided as methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a machine such as a general-purpose computer, a platform comprising user equipment such as a smart device, e.g., a smart phone, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode. For example, the instructions may be provided on a non-transitory computer readable storage medium encoded with instructions, executable by a processor.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer or software product, such as a non-transitory machine-readable storage medium, the computer software or product being stored in a storage medium and comprising a plurality of instructions, e.g., machine readable instructions, for making a computer device implement the methods recited in the examples of the present disclosure.

In some examples, some methods can be performed in a cloud-computing or network-based environment. Cloud-computing environments may provide various services and applications via the Internet. These cloud-based services (e.g., software as a service, platform as a service, infrastructure as a service, etc.) may be accessible through a web browser or other remote interface of the user equipment for example. Various functions described herein may be provided through a remote desktop environment or any other cloud-based computing environment.

While various embodiments have been described and/or illustrated herein in the context of fully functional computing systems, one or more of these exemplary embodiments may be distributed as a program product in a variety of forms, regardless of the particular type of computer-readable-storage media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein. In addition, one or more of the modules described herein may transform data, physical devices, and/or representations of physical devices from one form to another.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

1. A method for monitoring a condition of a vehicle comprising a sensor, the method comprising:
measuring, by the sensor, at least one characteristic of the vehicle;
transmitting the measurement to a remote processing module;
analysing, by the remote processing module, the received measurement to determine a metric indicative of the condition of the vehicle; and
transmitting the determined metric to the vehicle.

2. The method of claim 1, wherein the at least one characteristic of the vehicle comprises noise, vibration, and harshness.

3. The method of claim 1, wherein the at least one characteristic of the vehicle comprises at least one characteristic of a component of a vehicle.

4. The method of claim 3, wherein measuring, by the sensor, the at least one characteristic of the component of the vehicle comprises performing the measurement in relation to the particular component of the vehicle, whereby to obtain metrics relating to that particular component only, wherein the remote processing module analyses the received measurement to determine a metric indicative of the condition of the particular component.

5. The method of claim 1, wherein the metric indicative of the condition of the vehicle comprises a metric indicative of the condition of a component of a powertrain of the vehicle.

6. The method of claimclaim 1, wherein the measurements are transmitted to the remote processing module in real time.

7. The method of claim 1, further comprising the step of compressing the measurement before transmitting it to the cloud-based processing module.

8. The method of claim 1, wherein determining the metric indicative of the condition of the vehicle comprises comparing the received measurement to a threshold value.

9. The method of claim 3, further comprising measuring vehicle speed, acceleration, mass, and road inclination, and estimating a torque load of a component of the vehicle based thereon.

10. The method of claim 8, wherein the threshold value to which the measurement is compared to is selected based on a current operational mode of the vehicle.

11. The method of claim 10, wherein the threshold value to which the measurement is compared to is selected based on a speed of the component of the vehicle and the torque load of the component of the vehicle.

12. The method of claim 1, further comprising the step of transmitting the determined metric to an external entity.

13. The method of claim 1, further comprising the step of displaying a message in the vehicle in response to receiving the determined metric.

14. The method of claim 1, further comprising measuring a vehicle suspension angle when the vehicle is stationary, and determining a laden vehicle mass based thereon.

15. An apparatus for monitoring a condition of a vehicle, the apparatus comprising:
a processor;
a memory coupled to the processor, the memory configured to store program code executable by the processor, the program code comprising one or more instructions, whereby to cause the apparatus to:
receive, from the sensor, at least one characteristic of the vehicle measured by the sensor;
analyse the received measurement to determine a metric indicative of the condition of the vehicle; and
transmit the determined metric to the vehicle.

16. The apparatus of claim 15, wherein the program code comprises one or more further instructions, whereby to cause the apparatus to:
compare the received measurement to a threshold value stored in the memory to thereby determine the metric indicative of the condition of the vehicle.

17. The apparatus of claim 16, wherein the program code comprises one or more further instructions, whereby to cause the apparatus to:
determine a current operational mode of the vehicle; and
select the threshold value amongst a plurality of threshold values stored in the memory based on the determined operational mode of the vehicle.

18. The apparatus of claim 15, wherein the program code comprises one or more further instructions, whereby to cause the apparatus to:
transmit the determined metric to an external entity.

19. A machine-readable storage medium encoded with instructions for monitoring a condition of a vehicle, the instructions executable by a processor of an apparatus, whereby to cause the apparatus to:
receive, from the sensor, at least one characteristic of the vehicle measured by the sensor; analyse the received measurement to determine a metric indicative of the condition of the vehicle; and
transmit the determined metric to the vehicle.

20. The machine-readable storage medium of claim 19, encoded with further instructions executable by the processor of the apparatus, whereby to cause the apparatus to:
compare the received measurement to a threshold value stored in the memory to thereby determine the metric indicative of the condition of the vehicle.

21. The machine-readable storage medium of claim 19, encoded with further instructions executable by the processor of the apparatus, whereby to cause the apparatus to:
determine a current operational mode of the vehicle; and
select the threshold value amongst a plurality of threshold values stored in the memory based on the determined operational mode of the vehicle.
